(19) United States
(12) Patent Application Publication
(10) Pub. No.: US 2006/0171795 A1
(43) Pub. Date: Aug. 3, 2006

(54) Substantial embedment of metallic debris

(76) Inventors: Stephen Daniel Cromwell, Penryn, CA (US); Gregg Meyer, Roseville, CA (US); James David Hensley, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/046,386

(22) Filed: Jan. 28, 2005

(51) Int. Cl. F16B 35/04

(52) U.S. Cl. 411/426

(57) ABSTRACT

An apparatus in one example has a liquid lubricant having a viscosity and surface tension such that, during engagement of a first segment, which has a threaded portion, and a second segment, which has a plurality of threads which are interlockable with the threaded portion of the first segment, friction between the threads of the first and second segments is reduced and metallic debris becomes substantially embedded in the liquid lubricant.

### BACKGROUND

Computing systems utilize electronic components or other heat generating assemblies that generate a substantial amount of heat during operation. Heat sinks may be attached to such electronic components and assemblies in order to cool the components and assemblies. The heat sink may be attached directly to the heat generating assembly with screw fasteners, such as spring-loaded screw fasteners. Circuit boards, for example, may be fastened to one another or may be fastened into a card cage using similar spring-loaded screw fasteners.

Screw fasteners may produce debris during tightening due to the metallic threads scraping against one another. Also, screw threads can have metal shavings left on them from the manufacturing process. Therefore, metal debris can be generated even without high friction. When spring-loaded screw fasteners are used the loading increases the metal-to-metal contact pressure and leads to increased debris during tightening. Any debris that is generated may migrate to areas of the circuit board, for example, a printed circuit board, where the debris can cause electrical shorts. The increased loading may also make it more difficult to tighten the fasteners.

### SUMMARY

The invention in one implementation encompasses an apparatus. The apparatus comprises a liquid lubricant having a viscosity and surface tension such that, during engagement of a first segment, which has a threaded portion, and a second segment, which has a plurality of threads which are interlockable with the threaded portion of the first segment, friction between the threads of the first and second segments is reduced and metallic debris becomes substantially embedded in the liquid lubricant.

Another implementation of the invention encompasses a system. The system comprises a first segment having a threaded portion; a second segment having a plurality of threads which are interlockable with the threaded portion of the first segment; at least one thread of at least one of the first and second segment having a coating of a liquid lubricant; and the liquid lubricant having a viscosity and surface tension such that, during engagement of the first and second segments, friction between the threads of the first and second segments is reduced and metallic debris becomes substantially embedded in the liquid lubricant.

Yet another implementation of the invention encompasses a method. The method comprises placing a liquid lubricant over at least a portion of a first segment having external threads; tightening a second part having internal threads over the external threads, the tightening causing the internal and external threads to mate; and during engagement of the first and second segments, reducing formation of debris between the threads of the first and second segments via the liquid lubricant and substantially embedding any metallic debris in the liquid lubricant.

### DESCRIPTION OF THE DRAWINGS

Features of exemplary implementations of the invention will become apparent from the description, the claims, and the accompanying drawings in which:

FIG. 1 is a representation of one implementation of an apparatus that has a heat sink attachable to a heat-producing component on a circuit board.

FIG. 2 is a representation of an exemplary method for attaching the heat sink to the heat-producing component of FIG. 1.

FIG. 3 is a representation of another exemplary method for attaching the heat sink to the heat-producing component of FIG. 1.

### DETAILED DESCRIPTION

Referring to the BACKGROUND section above, thread lubricants have been used in the past to try to prevent generation of metallic debris in electronic assemblies and circuit boards. Exemplary thread lubricants comprise a product offered by offered by DuPont, Inc. (Wilmington Del., http://www.teflon.com) under the trade identifier Teflon™ and a product offered by offered by Whitford, Corp. (West Chester, Pa., http://www.whitfordww.com) under the trade identifier Xylan™. The thread lubricants are coated onto the threads and cured so that they remain much like paint does. Although these thread lubricants reduce friction and hence may reduce formation of metallic debris, they do not substantially eliminate the formation of metallic debris. Any debris that is generated may migrate to areas of the circuit board where it can cause electrical shorts. Thus, a need exists for a material that not only reduces friction between the threads of screw fasteners, but also substantially eliminates metallic debris.

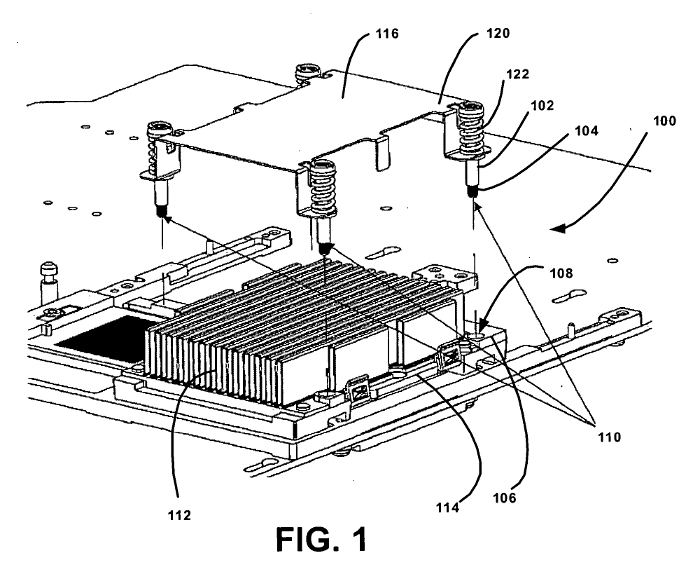

Turning to FIG. 1, an apparatus 100 may have a first segment 102 having a threaded portion 104, for example, a substantially cylindrical threaded portion. A second segment 106 may have a plurality of threads 108 which are interlockable with the threaded portion 104 of the first segment 102. At least one thread of at least one of the first and second segments 102, 106 may have a coating of a liquid lubricant 110. The liquid lubricant 110 may have a viscosity and surface tension such that, during engagement of the first and second segments 102, 106, friction between the threads of the first and second segments 102, 106 is reduced and metallic debris becomes substantially embedded in the liquid lubricant 110.

In the example depicted in FIG. 1, a heat sink 112 is operatively coupled to a heat-producing component or assembly 114 by a cover 116. The cover 116 may be attached to a circuit board 118, for example, a printed circuit board, by a fastening system of the apparatus 100. The fastening system may have one or more screw fasteners (e.g., first segment 102) that are received into corresponding threaded areas (e.g., second segment 106). As depicted in FIG. 1 the cover 116 may be substantially rectangular shaped and screw fasteners 102 may be located at corner areas 120 thereof.

The liquid lubricant 110 may be a synthetic liquid lubricant on the threads 104 of screw fasteners 102. Exemplary reasons for employing the lubricant in one implementation are now presented, for illustrative purposes. One reason is that the threaded interface on the screws and the device they thread into tends to generate metallic debris during tightening. These screws 102 usually compress a spring 122 to provide loading to retain the heat sink 112 against the component or assembly 114. Because of the load that is generated during compression of the spring 122 and the friction between the threads 104 of the screw 102 and the threads 108 of its mating component 106 the debris is generated. Adding the lubricant 110 reduces the friction and hence the generation of debris. Another reason is that the lubricant 110 is also fairly thick (it may have a viscosity comparable to 90W gear oil) so any debris that is generated is captured in the lubricant 110 and does not migrate to areas of the circuit board 118 where it can cause electrical shorts.

Since the liquid lubricant 110 has a fairly high viscosity and surface tension, it “sticks” to the threads quite well. During tightening of the screws 102 any metallic debris that is formed will become embedded in the lubricant 110 and remain there. It is not free to cause electrical shorts on the circuit board 118. The liquid lubricant 110 may also remain effective for a greater number of installation/removal cycles than the thread lubricants.

One example of the liquid lubricant may be SUPER LUBE OIL WITH PTFE manufactured by SYNCO CHEMICAL CORPORATION (Bohemia, N.Y., http://www.super-lube.com). Major components of this lubricant may include:

| | |
|---|---|
| SYNTHETIC HYDROCARBON | 75-85% |
| HYDRO TREATED POLYMER | 15-25% |
| ANTI-OXIDANT | 1-2% |
| FUMED SILICA | 1-5% |
| POLYTETRAFLUORETHYLENE | 2-4% |
| POLYGLYCOL | .5-1% |
| PROPRIETARY ADDITIVES | .25-1% |

In general some implementations may have a force component that produces a force on the threads of the first and second segments. In one example the force component that produces a force on the threads of the first and second segments may be a clamping load. Also, the force component may produce an axially directed force on the threads of the first and second segments. As depicted in FIG. 1, for example, the force on the threads of the first and second segments may be a spring force. Other implementations may omit the force component.

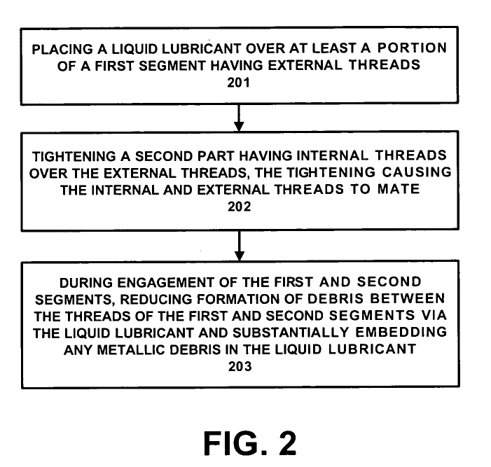

Referring to FIG. 2, one example of a method of lubricating a threaded connection includes: placing a liquid lubricant over at least a portion of a first segment having external threads (201); tightening a second part having internal threads over the external threads, the tightening causing the internal and external threads to mate (202); and during engagement of the first and second segments, reducing formation of debris between the threads of the first and second segments via the liquid lubricant and substantially embedding any metallic debris in the liquid lubricant (203).

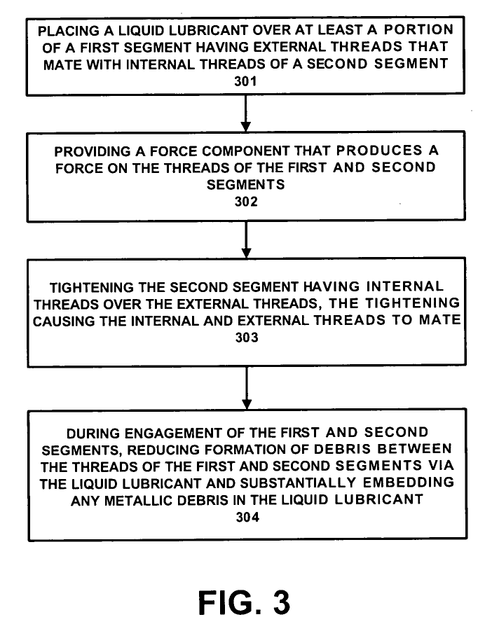

Referring to FIG. 3, another example of a method of lubricating a threaded connection includes: placing a liquid lubricant over at least a portion of a first segment having external threads that mate with internal threads of a second segment (301); providing a force component that produces a force on the threads of the first and second segments (302); tightening the second segment having internal threads over the external threads, the tightening causing the internal and external threads to mate (303); and during engagement of the first and second segments, reducing formation of debris between the threads of the first and second segments via the liquid lubricant and substantially embedding any metallic debris in the liquid lubricant (304).

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a liquid lubricant having a viscosity and surface tension such that, during engagement of a first segment, which has a threaded portion, and a second segment, which has a plurality of threads which are interlockable with the threaded portion of the first segment, friction between the threads of the first and second segments is reduced and metallic debris becomes substantially embedded in the liquid lubricant.

2. The apparatus of claim 1 wherein the lubricant is substantially a synthetic hydrocarbon.

3. The apparatus of claim 1 wherein the lubricant has a viscosity substantially equivalent to 90W gear oil.

4. A system, comprising:
a first segment having a threaded portion;
a second segment having a plurality of threads which are interlockable with the threaded portion of the first segment;
at least one thread of at least one of the first and second segment having a coating of a liquid lubricant; and
the liquid lubricant having a viscosity and surface tension such that, during engagement of the first and second segments, friction between the threads of the first and second segments is reduced and metallic debris becomes substantially embedded in the liquid lubricant.

5. The system of claim 4 wherein the fastening system further comprises a force component that produces a force on the threads of the first and second segments.

6. The system of claim 5 wherein the force component produces an axially directed force on the threads of the first and second segments.

7. The system of claim 5 wherein the force on the threads of the first and second segments is a spring force.

8. The system of claim 5 wherein the on the threads of the first and second segments is a clamping load.

9. The system of claim 4 wherein the lubricant is substantially a synthetic hydrocarbon.

10. The system of claim 4 wherein the lubricant has a viscosity substantially equivalent to 90W gear oil.

11. An apparatus, comprising:
a liquid lubricant having a viscosity and surface tension such that, during engagement of a first segment, which has a threaded portion, and a second segment, which has a plurality of threads which are interlockable with the threaded portion of the first segment, a force component producing a force on the threads of the first and second segments, friction between the threads of the first and second segments is reduced and metallic debris becomes substantially embedded in the liquid lubricant.

12. The apparatus of claim 11 wherein the force component produces an axially directed force on the threads of the first and second segments.

13. The apparatus of claim 11 wherein the force on the threads of the first and second segments is a clamping load.

14. The apparatus of claim 11 wherein the force on the threads of the first and second segments is a spring force.

15. The apparatus of claim 11 wherein the lubricant is synthetic hydrocarbon.

16. The apparatus of claim 11 wherein the lubricant has a viscosity substantially equivalent to 90W gear oil.

17. A method, comprising the steps of:
placing a liquid lubricant over at least a portion of a first segment having external threads;
tightening a second part having internal threads over the external threads, the tightening causing the internal and external threads to mate; and
during engagement of the first and second segments, reducing formation of debris between the threads of the first and second segments via the liquid lubricant and substantially embedding any metallic debris in the liquid lubricant.

18. The method of claim 17 wherein the lubricant is substantially a synthetic hydrocarbon.

19. The method of claim 17 wherein the lubricant has a viscosity substantially equivalent to 90W gear oil.

20. A method, comprising the steps of:
placing a liquid lubricant over at least a portion of a first segment having external threads that mate with internal threads of a second segment;
producing a force on the threads of the first and second segments;
tightening the second segment having internal threads over the external threads, the tightening causing the internal and external threads to mate; and
during engagement of the first and second segments, reducing formation of debris between the threads of the first and second segments via the liquid lubricant and substantially embedding any metallic debris in the liquid lubricant.

21. The method of claim 20 wherein the lubricant has a viscosity substantially equivalent to 90W gear oil.

22. The method of claim 20 wherein the lubricant is substantially a synthetic hydrocarbon.

23. The method of claim 20 wherein the force on the threads of the first and second segments is a clamping load.

24. The method of claim 20 wherein the force is an axially directed force on the threads of the first and second segments.

25. The method of claim 20 wherein the force on the threads of the first and second segments is a spring force.
